(19) United States
(12) Patent Application Publication
(10) Pub. No.: US 2011/0214684 A1
(43) Pub. Date: Sep. 8, 2011

(54) TOOTH CLEANING OBJECT

(76) Inventor: Yan-Zhang LIN, Nantou County (TW)

(21) Appl. No.: 12/716,801

(22) Filed: Mar. 3, 2010

(51) Int. Cl. A61C 15/04

(52) U.S. Cl. 132/323

(57) ABSTRACT

A tooth cleaning object comprises a force applying portion, a tooth cleaning portion connected to the force applying portion and at least one bracing portion bridging the tooth cleaning portion and the force applying portion. The force applying portion is vertical to the tooth cleaning portion. The tooth cleaning object of the invention can be easily used to clean user's molar teeth through the tooth cleaning portion. The bracing portion reinforces the connection of the force applying portion and the tooth cleaning portion so that it is not easily broken under a shearing force.

### FIELD OF THE INVENTION

The present invention relates to a tooth cleaning object and particularly to a tooth cleaning object to clean molar teeth with dental floss.

### BACKGROUND OF THE INVENTION

As people's living standard and knowledge growing higher, they also pay more attention on their oral hygiene. People's oral cavities have to be in touch frequently with air and foods, hence bacteria breed constantly in the oral cavity and result in erosion of teeth and decayed teeth. Nowadays the concept of teeth care is being highly promoted, many people have developed a habit of brushing teeth after meal. But carrying a toothbrush is inconvenient and finding a desirable place to brush teeth after meal often is difficult, hence using a toothpick or dental floss to clean teeth becomes increasingly popular and well accepted.

Research proves that the toothpick is prone to hurt people's gum and the effect of cleaning teeth is not desirable. Dental floss is more effective for teeth cleaning, but is quite awkward and inconvenient to use, hence is shunned by many people. To address this issue, dental floss stick has been developed and introduced. It is a practical and convenient tooth cleaning article. Please refer to FIG. 1 for a conventional dental floss stick. It has a stem 1 and a tooth picking portion 2 with a dental floss 3 attached thereon. The tooth picking portion 2 and the stem 1 are connected in a straight line. While such a structure can clean the front teeth easily, it cannot clean the molar teeth effectively. Hence the molar teeth are at risk of inflicting decay.

### SUMMARY OF THE INVENTION

The primary object of the present invention is to solve the problem of the conventional dental floss stick that cannot effectively clean the molar teeth.

To achieve the foregoing object, the invention provides a novel tooth cleaning object which includes a force applying portion to be grasped by a user when in use and a tooth cleaning portion connected to the force applying portion. The tooth cleaning portion has a distal bar connected to the force applying portion, two side bars extended from the distal bar and a piece of dental floss to bridge the two side bars. The tooth cleaning object of the invention thus structured provides features as follow: the distal bar and the force applying portion are connected vertically; the tooth cleaning object further includes at least one bracing portion to respectively connect with the tooth cleaning portion and the force applying portion to reinforce the junction formed between them.

By means of the structure set forth above, the distal bar and the force applying portion are connected vertically and the dental floss also is positioned perpendicularly to the force applying portion so that the tooth cleaning object of the invention can be easily disposed deeply in a user's oral cavity to clean the slits between the teeth. Moreover, the bracing portion provided by the invention respectively connects with the force applying portion and the distal bar to increase the linkage strength therebetween and can prevent breaking of the junction formed between them when subject to a shearing force.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional dental floss stick.

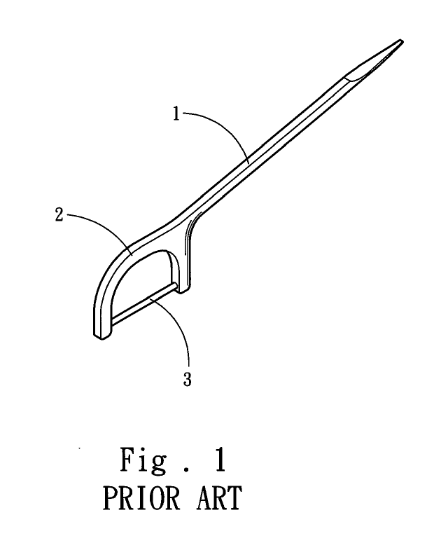

FIG. 2 is a perspective view of an embodiment of the tooth cleaning object of the invention.

FIG. 3 is a schematic view of an embodiment of the tooth cleaning object of the invention in a use condition.

### DETAILED DESCRIPTION OF THE PREFERRED EMBODIMENT

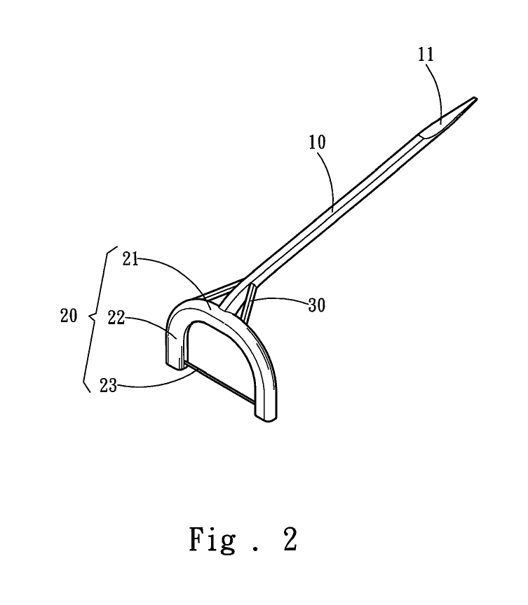

Please refer to FIG. 2, the present invention provides a tooth cleaning object which comprises a force applying portion 10 to be grasped by a user when in use and a tooth cleaning portion 20 connected to one end of the force applying portion 10. The force applying portion 10 has another end extended to form a pointed end 11. The tooth cleaning portion 20 includes a distal bar 21 connected to the force applying portion 10 and two side bars 22 extended from the distal bar 21 and a dental floss 23 bridging the two side bars 22. The tooth cleaning object of the invention provides features as follow: the distal bar 21 is connected perpendicularly to the force applying portion 10. The tooth cleaning object also has at least one bracing portion 30 with two ends respectively connected with the tooth cleaning portion 20 and the force applying portion 10 to reinforce the junctions formed with the force applying portion 10 and the tooth cleaning portion 20.

It is to be noted that, in an embodiment discussed above the force applying portion 10 is connected to the distal bar 21 of the tooth cleaning portion 20, and two bracing portions 30 each has two ends are respectively connected to the distal bar 21 and the force applying portion 10 to form a triangular support structure, thereby provide a firmer connection between the force applying portion 10 and the distal bar 21. Moreover, the two bracing portions 30 also can be connected to the force applying portion 10 from the side bars 22 to form another triangular support structure. The distal bar 21, aside from being extended to form the side bars 22, also can be formed by extending from the force applying portion 10. Thus the force applying portion 10, distal bar 21, side bars 22 and bracing portions 30 can be formed integrally in one piece.

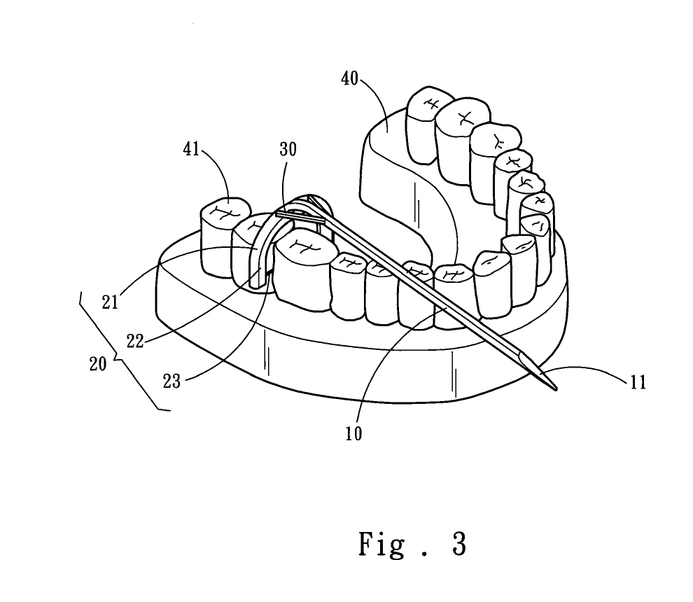

Refer to FIG. 3 for an embodiment in a use condition. Because of the force applying portion 10 is vertical to the tooth cleaning portion 20, the dental floss 23 also is vertical to the force applying portion 10. Hence user can easily position the tooth cleaning object deeply into the oral cavity 40 to clean the slits between the molar teeth 41.

As a conclusion, the invention provides the distal bar 21 and the force applying portion 10 that are connected in a vertical manner so that the dental floss 23 also is vertical to the force applying portion 10. Therefore, users can easily position the tooth cleaning object deeply into the oral cavity 40 to clean the slits between the molar teeth 41. Moreover, the invention also provides the bracing portions 30 to bridge the force applying portion 10 and the distal bar 21 to reinforce their connection to prevent the junctions between them from breaking under a shearing force. The structure of the invention further may be formed integrally in one piece to reduce the risk of breaking of the junctions between the distal bar 21 and the force applying portion 10 under the shearing force.

While the invention has been described by means of a specific embodiment, numerous modifications and variations could be made thereto by those skilled in the art without departing from the scope and spirit of the invention set forth in the claims.

In summation of the above description, the present invention provides a significant improvement over the conventional techniques and complies with the patent application requirements, and is submitted for review and granting of the commensurate patent rights.

What is claimed is:

1. A tooth cleaning object, comprising:
a force applying portion to be grasped by a user when in use; and
a tooth cleaning portion which includes a distal bar connected to the force applying portion, two side bars connected to two sides of the distal bar and a dental floss bridging the two side bars;
wherein the tooth cleaning portion is vertically connected to the force applying portion, the tooth cleaning object further including at least one bracing portion respectively bridging the tooth cleaning portion and the force applying portion.

2. The tooth cleaning object of claim 1, wherein the distal bar is extended from the force applying portion.

3. The tooth cleaning object of claim 1, wherein the force applying portion includes one end extended to form a pointed end opposite to the tooth cleaning portion.

4. The tooth cleaning object of claim 1, wherein the bracing portion comprises two sets each including two ends respectively connected to the force applying portion and the distal bar to form a triangular support structure.

5. The tooth cleaning object of claim 1, wherein the bracing portion comprises two sets each including two ends respectively connected to the force applying portion and the side bars to form another triangular support structure.

6. The tooth cleaning object of claim 1, wherein the bracing portion is extended from the force applying portion to the distal bar.
